(19) United States
(12) Patent Application Publication
(10) Pub. No.: US 2011/0156390 A1
(43) Pub. Date: Jun. 30, 2011

(54) METHOD FOR CONTROLLING A WIND TURBINE

(76) Inventors: Jesús Mayor Lusarreta, Sarriguren (Navarra) (ES); Iker Garmendia Olarreaga, Sarriguren (Navarra) (ES); Jorge Acedo Sánchez, Sarriguren (Navarra) (ES); Ainhoa Cárcar Mayor, Sarriguren (Navarra) (ES); David Solé López, Sarriguren (Navarra) (ES); Susana Simón Segura, Sarriguren(Navarra) (ES); Mikel Zabaleta Maeztu, Sarriguren (Navarra) (ES); Josu Elorriaga Llanos, Sarriguren (Navarra) (ES)

(21) Appl. No.: 12/999,372

(22) PCT Filed: Jun. 24, 2009
(86) PCT No.: PCT/ES2009/070244

§ 371 Date: Feb. 3, 2011

(30) Foreign Application Priority Data
Jun. 26, 2008 (ES) P200801911

(51) Int. Cl. H02P 9/04

(52) U.S. Cl. 290/44

(57) ABSTRACT

The proposed invention describes an alternative for machines with at least one power unit (101) formed by at least one first electronic converter (106) connected to the rotor (109) of the generator, at least one second electronic converter (107) capable of supplying or drawing off the power which the latter is using or producing, and at least one continuous bus (108); with the proposed method it is possible to control the power of the rotor (109), modifying the synchronization speed of the asynchronous generator (103) when it is disconnected from the electrical network supply (102), by means of variation of the frequency of the currents in the rotor (109) which are generated by the first electronic converter (106).

### OBJECT OF THE INVENTION

The present invention relates to a method for controlling the power of a wind turbine, particularly of those comprising a doubly-fed generator, usually connected to an electrical network.

### BACKGROUND OF THE INVENTION

In recent years the number of aerogenerators and wind farms connected to the electrical network has significantly increased. For this reason, the level of demand for these machines has increased by listing a number of performance requirements to improve the efficiency of the aerogenerator preventing mechanical stresses and obtaining a quick response in the presence of disturbances in the electrical network.

Currently, there are different solutions in the state of the art that meet the established performance requirements when failures in the network occur.

For example, the invention EP0984552B1 (Alstom) describes the connection of some resistors to the stator such that the actuation on these resistors, when the machine has been disconnected from the electrical network, for example following the occurrence of a failure therein, enables the turbine and generator voltage to be controlled.

The patent application WO04070936A1 (Vestas), describes a similar system applied to a doubly-fed wind turbine wherein the capacity of the frequency converter for contributing to the short-circuit current for the electrical network during failures is claimed. During the failure, the turbine speed is controlled by dissipating the power in the impedances connected in the stator and, in the chopper resistor connected in the continuous intermediate circuit of the converter. In this sense, the power transmitted by the rotor of the generator to the continuous bus through the converter, during deceleration of the generator, can be dissipated in the chopper of the continuous bus or shifted to the network, in case there is voltage therein.

The proposed invention describes an alternative for machines with at least one power unit formed by:
at least one first electronic converter connected to the rotor of the generator,
at least one second electronic converter capable of supplying or dissipating the power which said rotor of the generator is using or producing,
at least one continuous bus.

With the proposed method it is possible to control the power of the rotor by modifying the synchronization speed of the asynchronous generator when it is disconnected from the electrical network.

### DESCRIPTION OF THE INVENTION

In a doubly fed machine the rotor power (Pᵣ) depends on the sliding (s) of the asynchronous machine and the power extracted from the stator (Pₛ):

Pᵣ=s·Pₛ

Said sliding is defined as:

$$s = \frac{{ω}_{r} - {ω}_{s}}{{ω}_{s}}$$

Wherein:

ωᵣ: rotor speed.

ωₛ: synchronization speed.

Synchronization speed is determined by the frequency of the electrical network, as long as the asynchronous generator is coupled to the electrical network.

In the present invention, in cases involving the stator disconnection of the asynchronous generator from the network, it is claimed a method by which rotor power is controlled regardless of its rotor speed. This is achieved by modifying the synchronization speed of the generator. It is known that the ratio between speed and frequency responses to the following formula:

$$ω = \frac{60 \cdot f}{p}$$

Wherein:

ω=machine speed in revolutions/minute (r.p.m.).

ƒ=electrical frequency.

ρ=number of pole pairs in the generator.

The frequencies of the stator and rotor are related according to the following formula:

ƒₛ=ƒᵣ+ƒ_{w}

ƒₛ: frequency of the currents in the stator (frequency corresponding to the synchronization speed)

ƒᵣ: frequency of the currents in the rotor

ƒ_{w}: electrical frequency corresponding to the rotor speed

The previous ratio shows how the frequency ƒₛ is imposed by the electrical network (50-60 Hz) when the generator is coupled to the network, which means that the frequency of the currents in the rotor will be set by the speed according to the following expression:

ƒᵣ=ƒₛ−ƒ_{w}

When the generator is decoupled, the frequency in the stator (ƒₛ) is not imposed by the electrical network and it only depends on the frequency of the currents in the rotor and on the rotor speed. Therefore, by controlling the frequency of the currents in the rotor it is possible to control the sliding of the asynchronous generator regardless of the rotor speed. This allows having a total control on the rotor power by only using the first electronic converter connected to the rotor of the generator. Consequently, even in conditions in which the second electronic converter is deactivated, the continuous bus voltage can be maintained within the established limits without the need of a chopper in the continuous bus.

The invention consists of a method for controlling a wind turbine for generators that are connected to the electrical network and are of asynchronous type with wound rotor, having at least one first electronic converter connected to the rotor and at least one load capable of being connected to the stator, so that it foresees the stator disconnection from the electrical network and also the connection of the load to the stator is carried out, where it is required that the stator is disconnected from the electrical network. The novelty of the invention is the incorporation of an operating mode consisting of modifying the frequency of the currents in the rotor of the generator, thus controlling the power flow between the rotor of the generator and the first electronic converter, during the stator disconnection of the generator from the electrical network and its connection to the resistors.

In addition, the power flow between the rotor of the generator and the first electronic converter can be established so that the continuous bus voltage of the power unit is controlled, so that if said voltage decreases the power extracted from the rotor of the generator increases, and vice versa. The objective of said control is to maintain the bus voltage within an operating range.

### BRIEF DESCRIPTION OF THE DRAWINGS

FIG. 1.—Shows a topology wherein the method of the described invention can be applied.

### DESCRIPTION OF ONE OR SEVERAL EMBODIMENTS OF THE INVENTION

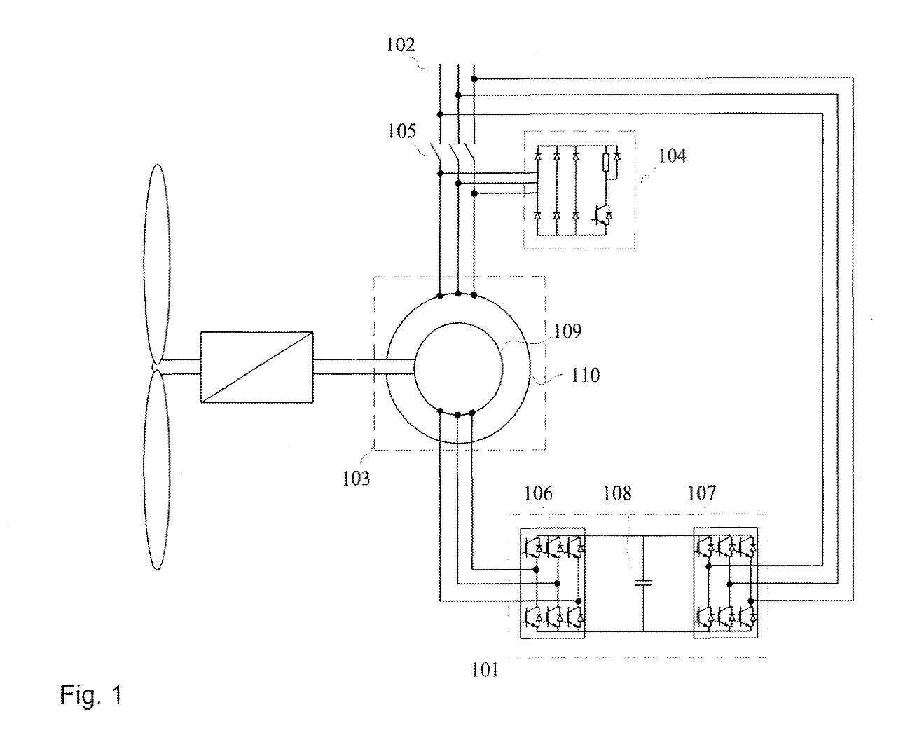

A description of examples of the invention is now made, with reference to FIG. 1.

The present invention describes a method for controlling a wind turbine during its disconnection from the electrical network (102) for asynchronous-type generators (103) with wound rotor (109) having at least one power unit (101) connected to the rotor (109) of the generator and comprising the following conventional phases:
Detecting inlet conditions in the isolated operating mode. By isolated operating mode is understood as any situation in which the stator (110) of the generator is decoupled from the electrical network (102). These situations could include, among others, gaps in the electrical network voltage, and any other requirement involving the quick disconnection.
Disconnecting the stator (110) from the electrical network (102) when the isolated operating mode is required, by opening the contactor (105) connecting the stator (110) to the electrical network (102).
Controlling a first electronic converter (106) of the power unit (101), by which it is connected to the rotor (109) of the generator to maintain the voltage module in the stator of the generator at the desired value, for example, its nominal value.
Connecting a load (104) to the stator and modulating the consumption of said load (104) to control the power generated by the stator (110) and thus control the machine speed. This load may be of resistive-type.
Detecting output conditions in the isolated operating mode, when conditions necessary for the operation coupled to the electrical network are given.
Synchronizing and connecting the stator of the generator to the electrical network (102), by switching off the contactor (105).
Disconnecting the resistors (104).

The novelty of the invention is that the previous phases are carried out maintaining, at all times, the control of the frequency of the currents in the rotor generated by the first electronic converter (106) of the power unit (101) connected to the rotor of the generator. One of the advantages of this method is to allow the control and maintenance of the continuous bus (108) voltage. Since the control of the frequency of the currents in the rotor is maintained at all times, a preferred embodiment of the invention may not be provided with the braking chopper located in the continuous bus (108) of the power unit (101), thus preventing the addition of further elements.

In a preferred embodiment, the second electronic converter (107) connected to the electrical network (102) can be deactivated during the disconnection period, for example, in case of a gap in the mains voltage, the semiconductors of the second electronic converter (107) might stop switching since by having no mains voltage it would not be possible to exchange power between the continuous bus and the electrical network.

1. Method for controlling a wind turbine applied to generators connected to the electrical network of the asynchronous type with wound rotor, having at least one first electronic converter connected to the rotor and at least a load capable of being connected to the stator, and comprising the stator disconnection from the electrical network and its connection to the load; characterized in that, during the stator disconnection of the generator from the electrical network and its connection to the load, it comprises:
varying the frequency of the currents in the rotor generated by the first electronic converter connected to the rotor of the generator in order to control the power flow between the rotor of the generator and the first electronic converter.

2. Method for controlling a wind turbine according to claim 1, having at least one power unit including at least the first electronic converter and at least one continuous bus, characterized in that it comprises maintaining the continuous bus voltage within a working range by controlling the power flow between the rotor of the generator and the first electronic converter.
